(19) United States
(12) Patent Application Publication
(10) Pub. No.: US 2008/0261117 A1
(43) Pub. Date: Oct. 23, 2008

(54) NON-AQUEOUS ELECTROLYTE SECONDARY CELL

(75) Inventors: Masato IWANAGA, Osaka (JP); Nobumichi NISHIDA, Osaka (JP); Satoshi YAMAMOTO, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/038,567

(22) Filed: Feb. 27, 2008

(30) Foreign Application Priority Data
Feb. 27, 2007 (JP) 2007-47266

(51) Int. Cl. H01M 10/26; H01M 4/40

(52) U.S. Cl. 429/231.95; 429/338

(57) ABSTRACT

A non-aqueous electrolyte secondary cell having a high cycle characteristic and excellence in continuous charging characteristic at high potential is provided. The non-aqueous electrolyte secondary cell comprises a positive electrode having a positive electrode active material, a negative electrode having a negative electrode active material, and a non-aqueous electrolyte having a non-aqueous solvent and electrolytic salt. The positive electrode contains lithium phosphate. The non-aqueous solvent contains a halogenated ethylene carbonate compound represented by chemical formula 1:

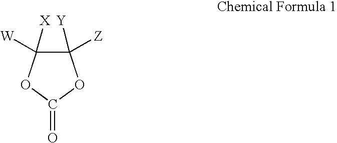

where W, X, Y, and Z independently represent a halogen or a hydrogen atom, at least one selected from W, X, Y, and Z being a halogen.

### BACKGROUND OF THE INVENTION

1) Field of the Invention

The present invention relates to technology for improving the cell characteristics of non-aqueous electrolyte secondary cells.

2) Description of the Related Art

Non-aqueous electrolyte secondary cells, for their high energy density and high capacity, are widely used as power sources for mobile phones. In recent years, there has been rapid enhancement of functionality of mobile information terminals such as mobile phones and laptop computers, resulting in a need for cells of higher capacity.

In order to meet this demand, an attempt is being made to enhance the efficiency of the positive electrode active material by charging the positive electrode to higher potentials (than the conventional potential of approximately 4.3V on the basis of lithium).

However, enhancing the potential of the positive electrode causes the non-aqueous electrolyte to react with the positive electrode and thereby be decomposed, posing the problem of degraded cycle characteristic.

Examples of the prior arts related to non-aqueous electrolyte secondary cells include Japanese Patent Application Publication Nos. 2003-308842 (patent document 1), 2005-38722 (patent document 2), 2005-71641 (patent document 3), 10-154532 (patent document 4), 9-306547 (patent document 5), and 2001-501355 (patent document 6).

Patent document 1 discloses use of, as the positive electrode, lithium manganese nickel oxide and lithium phosphate. This technique is claimed to realize a cell having high voltage and excellent charge/discharge characteristics.

This technique, however, cannot sufficiently inhibit the reaction between the high potential positive electrode and the non-aqueous electrolyte, posing the problem of poor cycle characteristic.

Patent document 2 discloses addition of fluorinated cyclic ester to the electrolyte. This technique is claimed to improve the cycle characteristic and prevent gas generation during high-temperature storage.

This technique, however, poses the problem of insufficient continuous charging characteristic under high-potential charge conditions.

Patent document 3 discloses addition of lithium phosphate to the non-aqueous electrolyte. This technique is claimed to inhibit occurrence of hydrofluoric acid.

This technique, however, cannot sufficiently inhibit the reaction between the high potential positive electrode and the non-aqueous electrolyte, posing the problem of poor cycle characteristic.

Patent document 4 discloses addition of lithium phosphate to the positive electrode. This technique is claimed to realize a cell excellent in security at the time of overcharge.

However, the document provides no reference to the cycle characteristic and the continuous charging characteristic of the non-aqueous electrolyte cell using a high-potential positive electrode.

Patent document 5 discloses addition of lithium phosphate to the positive electrode. This technique is claimed to realize a cell with reduced self-discharging.

However, the document provides no reference to the cycle characteristic and the continuous charging characteristic of the non-aqueous electrolyte cell using a high-potential positive electrode.

Patent document 6 discloses use of fluoroethylene carbonate as the electrolyte. This technique is claimed to realize a cell with a small irreversible capacity.

This technique, however, poses the problem of insufficient continuous charging characteristic at the time of high-potential charging.

### SUMMARY OF THE INVENTION

The present invention has been accomplished in order to solve the above problems, and it is an object of the present invention to provide a non-aqueous electrolyte secondary cell capable of inhibiting the reaction between the positive electrode and the non-aqueous electrolyte even when in use at high potential and having excellent continuous charging characteristic.

In order to accomplish the above-mentioned object, a non-aqueous electrolyte secondary cell according to the present invention comprises: a positive electrode having a positive electrode active material; a negative electrode having a negative electrode active material; and a non-aqueous electrolyte having a non-aqueous solvent and electrolytic salt, wherein: the positive electrode contains lithium phosphate; and the non-aqueous solvent contains a halogenated ethylene carbonate compound represented by chemical formula 1:

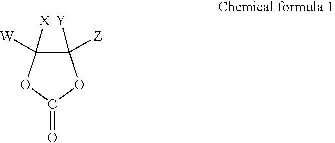

wherein W, X, Y, and Z independently represent a halogen or a hydrogen atom, at least one selected from W, X, Y, and Z being a halogen.

In this configuration, the non-aqueous electrolyte contains a halogenated ethylene carbonate compound. The halogenated ethylene carbonate compound serves to inhibit the reaction between the positive electrode at high potential and the non-aqueous electrolyte, thereby improving the cycle characteristic of the cell. However, it does not suffice to add only the halogenated ethylene carbonate compound to the non-aqueous solvent. That is, when a non-aqueous electrolyte secondary cell containing the halogenated ethylene carbonate compound is continuously charged under high-potential conditions, the halogenated ethylene carbonate compound reacts with the negative electrode and is thereby decomposed. The decomposed substance is oxidized at the positive electrode and thus poses the problem of generating a large amount of gas. In view of this, in the above-described configuration of the present invention, the positive electrode contains lithium phosphate while the non-aqueous solvent contains a halogenated ethylene carbonate compound represented by chemical formula 1. Containing lithium phosphate in the positive electrode inhibits gas generation at the time of continuous charging, although the reason therefor is still unclear. This drastically improves the continuous charging resistance of the cell.

As used herein, the continuous charging means keeping the voltage of a charged cell to the one at the time of completion of charging by continuously applying current and voltage to the cell. Also the continuous charging resistance means the credibility of the cell at the time of continuous charging. That is, the continuous charging resistance means whether various kinds of cell performance are maintained at the time of continuous charging.

In the above basic configuration, the halogenated ethylene carbonate compound represented by chemical formula 1 may be 1.0 to 40 volume % in the non-aqueous solvent at 25° C. and 1 atm.

If the content of the halogenated ethylene carbonate compound is significantly small, the advantageous effects of the halogenated ethylene carbonate compound cannot be obtained sufficiently. If an excessive amount of the halogenated ethylene carbonate compound is contained, since it is highly viscous, the non-aqueous electrolyte is rendered highly viscous, thereby degrading the cycle characteristic. In view of this, the halogenated ethylene carbonate compound is preferably specified within the claimed range. A more preferable range is 15 to 35 volume %.

In the above basic configuration, the lithium phosphate contained in the positive electrode may be 0.5 to 5 mass parts relative to the total mass of the positive electrode active material and the lithium phosphate, the total mass being assumed 100 mass parts.

If the content of the lithium phosphate is significantly small, the desired advantageous effect cannot be obtained sufficiently. If an excessive amount of the lithium phosphate is contained, since it is not a contributory substance to charging and discharging, the discharge capacity is reduced. In view of this, the content of the lithium phosphate is preferably specified within the claimed range.

Examples of the halogenated ethylene carbonate compound include chlorinated ethylene carbonate, brominated ethylene carbonate, and fluorinated ethylene carbonate, among which fluorinated ethylene carbonate is preferred because it is most effective.

In the above basic configuration, the positive electrode active material may have a potential of 4.3 to 5.2 V on the basis of lithium, more preferably 4.4 to 5.2 V.

The advantageous effects of the present invention are notable when the inventive configuration is applied to cells that are charged to higher potentials than normal (i.e., than 4.3V on the basis of lithium). However, if the cell is charged to more than 5.2 V for the potential of the positive electrode active material, the structural stability of the positive electrode active material is degraded, thereby degrading the discharge characteristic and the like. In view of this, the potential of the positive electrode active material is preferably specified within the claimed range.

Thus, the present invention provides the significant effect of providing a high-capacity non-aqueous electrolyte secondary cell that functions stably at a high potential of 4.3 to 5.2 V on the basis of lithium, inhibits the reaction between the high potential positive electrode and the non-aqueous electrolyte, and excels in continuous charging resistance.

### BRIEF DESCRIPTION OF THE DRAWINGS

FIG. 1 is a perspective, longitudinally cutaway, view of a cylindrical non-aqueous electrolyte secondary cell according to example 1 of the present invention.

### DESCRIPTION OF THE PREFERRED EMBODIMENTS

The preferred embodiments of the present invention will be described with reference to examples. It will be understood that the present invention will not be limited by the embodiments below; modifications are possible without departing from the scope of the present invention.

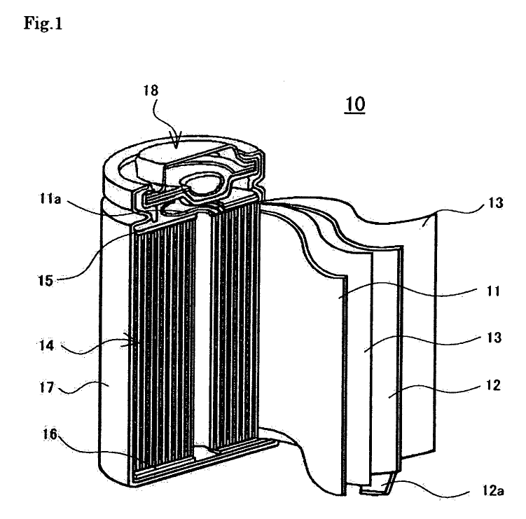

A non-aqueous electrolyte secondary cell according to the present example has a structure shown in FIG. 1. The non-aqueous electrolyte secondary cell 10 has a wound electrode assembly 14 with a positive electrode 11 and a negative electrode 12 wound with a separator 13 therebetween. Above and under the wound electrode assembly 14, insulation plates 15 and 16 are placed.

The non-aqueous electrolyte and the wound electrode assembly 14 are incorporated in a cylindrical steel cell outer casing 17 that also serves as a negative electrode terminal. The negative electrode 12 has a current collector 12a welded to the inner bottom of the cell outer casing 17. The positive electrode 11 has a current collector 11a welded to a bottom plate of a current cut-off seal plate 18 provided with a safety device. The current cut-off seal plate 18 hermetically seals the cell outer casing 17. The current cut-off seal plate 18 also has the function of, upon increase in the cell internal pressure, cutting off external electrical connection of the wound electrode assembly 14. The connection, once cut off, cannot be regained even though the pressure is released.

### Example 1

### Preparation of the Positive Electrode

Lithium carbonate and a co-precipitated hydroxide represented by Ni_{0.33}Cu_{0.34}Mn_{0.33}(OH)₂ were mixed, and then baked in an air atmosphere at 1000° C. for 20 hours, followed by cracking, thus obtaining lithium nickel-cobalt-manganese oxide (positive electrode active material A: LiNi_{0.33}Cu_{0.34}Mn_{0.33}O₂).

Cobalt (Co), zirconium (Zr), aluminum (Al), and magnesium (Mg) were co-precipitated to have a thermal decomposition reaction, thus obtaining tricobalt tetraoxide containing zirconium, aluminum, and magnesium. The tricobalt tetraoxide was mixed with lithium carbonate, and then baked in an air atmosphere at 850° C. for 24 hours, followed by cracking, thus obtaining lithium-cobalt composite oxide containing zirconium, aluminum, and magnesium (positive electrode active material B).

The positive electrode active material A and the positive electrode active material B were mixed with one another at a mass ratio of 1:9, and 99 mass parts of this mixture and 1 mass part of lithium phosphate having an average grain diameter of 5 μm were mixed with one another.

Ninety-four mass parts of the mixture, 3 mass parts of acetylene black as a conducting agent, 3 mass parts of polyvinylidene fluoride (PVDF) as a binding agent, and N-methyl-2-pyrrolidone (NMP) were mixed together, thus preparing a positive electrode active material slurry. This positive electrode active material slurry was applied to both surfaces of a positive electrode current collector (15 μm thick) made of an aluminum foil by doctor blading, followed by drying to remove the solvent (NMP) required during slurry preparation. Then, the dried electrode plate was rolled to a thickness of 140 μm. Then, the positive electrode current collector tab 11a was attached to a core exposed portion, thus preparing a positive electrode.

### Preparation of the Negative Electrode

Ninety-six mass parts of a negative electrode active material made of graphite, 2 mass parts of carboxymethyl cellulose (CMC) as a thickening agent, 2 mass parts of styrene-butadiene rubber (SBR) as a binding agent, and water were mixed together, thus preparing a negative electrode active material slurry. The negative electrode active material slurry was applied to both surfaces of a negative electrode current collector (8 μm thick) made of copper, followed by drying to remove the water required during slurry preparation. Then, the dried electrode plate was rolled to a thickness of 140 μm. Then, the negative electrode current collector tab 12a was attached to a core exposed portion, thus preparing a negative electrode.

The potential of graphite is 0.1 V on the basis of lithium. The amounts of the active materials filled in the positive electrode and the negative electrode were adjusted such that the charge capacity ratio (negative electrode charge capacity/positive electrode charge capacity) per unit area would be “negative electrode≧positive electrode” at the potential of the positive electrode active material (4.45 V on the basis of lithium in this example, while the voltage being 4.35 V), which serves as a design reference.

### Preparation of the Electrode Assembly

The positive electrode and the negative electrode were wound with a separator made of a polyolefin porous film (18 μm thick) disposed therebetween, thus preparing an electrode assembly.

### Preparation of the Non-Aqueous Electrolyte

Fluorinated ethylene carbonate (FEC) represented by chemical formula 1 show below, dimethyl carbonate (DMC), and ethyl methyl carbonate (EMC) were mixed together at a volume ratio of 20:40:40 (25° C., 1 atm.), and then LiPF₆ as electrolytic salt was dissolved therein at a rate of 1.1 (mol/liter), thus obtaining a non-aqueous electrolyte.

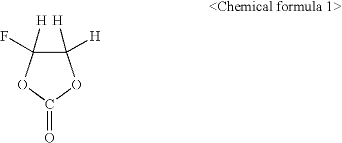

### Assembly of the Cell

The electrode assembly was inserted into an outer casing along with insulation plates, and the negative electrode current collector tab was welded to the bottom of the outer casing. The non-aqueous electrolyte was then injected into the outer casing. Then, the positive electrode current collector tab was welded to a sealing plate provided with a current cut-off valve, a safety valve, a PTC element, and a terminal cap, followed by sealing the opening of the outer casing with the sealing plate. Thus, a non-aqueous electrolyte secondary cell according to example 1 having a diameter of 18 mm and a height of 65 mm was prepared.

### Example 2

A non-aqueous electrolyte secondary cell according to example 2 was prepared in the same manner as in example 1 except that the fluorinated ethylene carbonate (FEC), ethylene carbonate (EC), dimethyl carbonate (DMC), and ethyl methyl carbonate (EMC) were mixed together at a volume ratio of 10:10:40:40 (25° C., 1 atm.).

### Example 3

A non-aqueous electrolyte secondary cell according to example 3 was prepared in the same manner as in example 1 except that the fluorinated ethylene carbonate (FEC), dimethyl carbonate (DMC), and ethyl methyl carbonate (EMC) were mixed together at a volume ratio of 40:30:30 (25° C., 1 atm.).

### Example 4

A non-aqueous electrolyte secondary cell according to example 4 was prepared in the same manner as in example 1 except that the positive electrode active material A and the positive electrode active material B were mixed with one another at a mass ratio of 1:9, and 99.5 mass parts of this mixture and 0.5 mass part of lithium phosphate having an average grain diameter of 5 μm were mixed with one another.

### Comparative Example 1

A non-aqueous electrolyte secondary cell according to comparative example 1 was prepared in the same manner as in example 1 except that lithium phosphate was not added, and ethylene carbonate (EC) was used instead of fluorinated ethylene carbonate (FEC).

### Comparative Example 2

A non-aqueous electrolyte secondary cell according to comparative example 2 was prepared in the same manner as in example 1 except that lithium phosphate was not added.

### Comparative Example 3

A non-aqueous electrolyte secondary cell according to comparative example 3 was prepared in the same manner as in example 1 except that ethylene carbonate (EC) was used instead of fluorinated ethylene carbonate (FEC).

### Comparative Example 4

A non-aqueous electrolyte secondary cell according to comparative example 4 was prepared in the same manner as in example 1 except that the positive electrode active material A and the positive electrode active material B were mixed with one another at a mass ratio of 1:9, and 99.9 mass parts of this mixture and 0.1 mass part of lithium phosphate having an average grain diameter of 5 μm were mixed with one another.

The cells were charged at a constant current of 1000 mA to a voltage of 4.35 V, then at a constant voltage of 4.35 V to a current of 54 mA. The cells were kept to a constant voltage of 4.35 V by constantly applying thereto voltage and current at 60° C., and the time before charging was disabled by actuation of the current cut-off valve was measured (continuous charging resistance). The case where the current cut-off valve was actuated in less than 200 hours was estimated level 1, the case where the current cut-off valve was actuated in 200 hours or more and less than 300 hours was estimated level 2, and the case that took 300 hours or more before actuation was estimated level 3. The results are shown in Table 1.

TABLE 1

| | Non-aqueous solvent | | | | | |
|---|---|---|---|---|---|---|
| | composition (volume %, | | | | Lithium | Continuous |
| | 25° C., 1 atm.) | | | | phosphate (mass | charging |
| | FEC | EC | DMC | EMC | parts) | resistance |
| Comparative | — | 20 | 40 | 40 | 0 | Level 1 |
| example 1 | | | | | | |
| Comparative | 20 | — | 40 | 40 | 0 | Level 1 |
| example 2 | | | | | | |
| Comparative | — | 20 | 40 | 40 | 1 | Level 1 |
| example 3 | | | | | | |
| Comparative | 20 | — | 40 | 40 | 0.1 | Level 1 |
| example 4 | | | | | | |
| Example 4 | 20 | — | 40 | 40 | 0.5 | Level 3 |
| Example 1 | 20 | — | 40 | 40 | 1 | Level 3 |
| Example 2 | 10 | 10 | 40 | 40 | 1 | Level 2 |
| Example 3 | 40 | — | 30 | 30 | 1 | Level 2 |

Level 1: less than 200 hours
Level 2: 200 hours or more to less than 300 hours
Level 3: 300 hours or more

Table 1 shows that examples 1 to 4, which contain fluorinated ethylene carbonate (FEC) in the non-aqueous solvent and have added therein 0.5 mass parts or more lithium phosphate (Li₃PO₄), are estimated level 2 or 3 for respective continuous charging resistance, which is superior to level 1 for that of comparative examples 1 to 4, which do not contain lithium phosphate and/or fluorinated ethylene carbonate.

A possible explanation for the results is as follows. Fluorinated ethylene carbonate has a halogen (fluorine) in its molecule structure. This structure serves to inhibit the reaction between the positive electrode at high potential and the non-aqueous electrolyte. Since ethylene carbonate does not have a halogen, the reaction between the positive electrode at high potential and the non-aqueous electrolyte cannot be inhibited sufficiently. Lithium phosphate serves to inhibit gas generation caused by decomposition of fluorinated ethylene carbonate at the time of continuous charging. Thus, fluorinated ethylene carbonate and lithium phosphate collaborate to significantly inhibit the decomposition of the non-aqueous electrolyte to thereby significantly reduce gas generation. As a result, the continuous charging resistance is drastically enhanced. If either fluorinated ethylene carbonate or lithium phosphate is missing, the decomposition of the non-aqueous electrolyte and fluorinated ethylene carbonate cannot be inhibited sufficiently, resulting in degraded continuous charging resistance.

Table 1 also shows that example 2, which has a fluorinated ethylene carbonate content of 10 volume %, and example 3, which has a fluorinated ethylene carbonate content of 40 volume %, are estimated level 2 for respective continuous charging resistance, which is slightly inferior to level 3 for that of example 1, which has a fluorinated ethylene carbonate content of 20 volume %.

A possible explanation for the results is as follows. If the content of fluorinated ethylene carbonate is significantly small, the effect of the fluorinated ethylene carbonate inhibiting the decomposition of the non-aqueous electrolyte at the positive electrode cannot be obtained sufficiently. If an excessive amount of fluorinated ethylene carbonate is contained, the fluorinated ethylene carbonate is decomposed at the time of continuous charging even though lithium phosphate is added. In view of this, the content of fluorinated ethylene carbonate is preferably more than 10 volume % and less than 40 volume %, more preferably 15 to 35 volume %.

(Supplementary Remarks)

While in the above examples a halogenated ethylene carbonate compound is used, chlorinated ethylene carbonate, brominated ethylene carbonate, iodinated ethylene carbonate, and the like may be used. A halogenated ethylene carbonate compound containing two or more halogens may be used (it being possible that the two or more halogens are the same or different). Further, a mixture of a plurality of kinds of halogenated ethylene carbonate may be used.

The positive electrode is not limited to layered lithium nickel-cobalt-manganese oxide and lithium-cobalt oxide containing different kinds of metal, as used in the above examples. Examples of the positive electrode active material suitable for use at high potential include, other than those used in the above examples, spinel lithium-manganese oxide and spinel lithium-manganese oxide having added thereto an element of different kind.

While in the above examples a cylindrical cell is exemplified, the present invention also finds applications in rectangular cells and cells using laminated outer casings. For the rectangular cells and cells using laminated outer casings, although increase in the cell internal pressure causes cell swelling, the structure of the present invention inhibits gas generation and thus provides the effect of inhibiting cell swelling.

### INDUSTRIAL APPLICABILITY

As has been described above, the present invention realizes a non-aqueous electrolyte secondary cell having high cycle characteristic and excellent continuous charging characteristic at high potential. Thus, the industrial applicability of the present invention is considerable.

What is claimed is:

1. A non-aqueous electrolyte secondary cell comprising:
a positive electrode having a positive electrode active material;
a negative electrode having a negative electrode active material; and
a non-aqueous electrolyte having a non-aqueous solvent and electrolytic salt, wherein:
the positive electrode contains lithium phosphate; and
the non-aqueous solvent contains a halogenated ethylene carbonate compound represented by chemical formula 1: 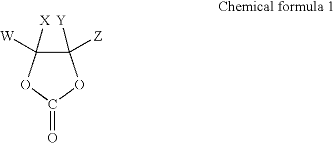
where W, X, Y, and Z independently represent a halogen or a hydrogen atom, at least one selected from W, X, Y, and Z being a halogen.

2. The non-aqueous electrolyte secondary cell according to claim 1, wherein the halogenated ethylene carbonate compound represented by chemical formula 1 is 1 to 40 volume % in the non-aqueous solvent at 25° C. and 1 atm.

3. The non-aqueous electrolyte secondary cell according to claim 1, wherein the lithium phosphate contained in the positive electrode is 0.5 to 5 mass parts relative to a total mass of the positive electrode active material and the lithium phosphate, the total mass being assumed 100 mass parts.

4. The non-aqueous electrolyte secondary cell according to claim 1, wherein the halogenated ethylene carbonate compound is fluorinated ethylene carbonate.

5. The non-aqueous electrolyte secondary cell according to claim 1, wherein the positive electrode active material has a potential of 4.3 to 5.2 V on the basis of lithium.

6. The non-aqueous electrolyte secondary cell according to claim 1, wherein the positive electrode active material has a potential of 4.4 to 5.2 V on the basis of lithium.

7. The non-aqueous electrolyte secondary cell according to claim 2, wherein the lithium phosphate contained in the positive electrode is 0.5 to 5 mass parts relative to a total mass of the positive electrode active material and the lithium phosphate, the total mass being assumed 100 mass parts.

8. The non-aqueous electrolyte secondary cell according to claim 2, wherein the halogenated ethylene carbonate compound is fluorinated ethylene carbonate.

9. The non-aqueous electrolyte secondary cell according to claim 2, wherein the positive electrode active material has a potential of 4.3 to 5.2 V on the basis of lithium.

10. The non-aqueous electrolyte secondary cell according to claim 2, wherein the positive electrode active material has a potential of 4.4 to 5.2 V on the basis of lithium.

11. The non-aqueous electrolyte secondary cell according to claim 3, wherein the halogenated ethylene carbonate compound is fluorinated ethylene carbonate.

12. The non-aqueous electrolyte secondary cell according to claim 3, wherein the positive electrode active material has a potential of 4.3 to 5.2 V on the basis of lithium.

13. The non-aqueous electrolyte secondary cell according to claim 3, wherein the positive electrode active material has a potential of 4.4 to 5.2 V on the basis of lithium.

14. The non-aqueous electrolyte secondary cell according to claim 4, wherein the positive electrode active material has a potential of 4.3 to 5.2 V on the basis of lithium.

15. The non-aqueous electrolyte secondary cell according to claim 4, wherein the positive electrode active material has a potential of 4.4 to 5.2 V on the basis of lithium.
